(19) United States
(12) Patent Application Publication
(10) Pub. No.: US 2005/0120019 A1
(43) Pub. Date: Jun. 2, 2005

(54) Method and apparatus for the automatic identification of unsolicited e-mail messages (SPAM)

(75) Inventors: Isidore Rigoutsos, Astoria, NY (US); Tien Huynh, Yorktown Heights, NY (US)

Correspondence Address: Gail H. Zarick;IBM Corporation, Intellectual Property Law Dept., P.O. Box 218, Yorktown Heights, NY, 10598, US

(73) Assignee: International Business Machines Corporation, Armonk, NY (US)

(21) Appl. No.: 10/724,585

(22) Filed: Nov. 29, 2003

(51) Int. Cl. G06F 7/00

(52) U.S. Cl. 707/6

(57) ABSTRACT

Techniques for annotating email messages. In one aspect of the invention, a method is provided for annotating a query email message. According to the method, patterns associated with a database, comprising annotated email messages, which may typically be known unwelcome email messages (“SPAM), are accessed, as by use of a pattern discovery algorithm (e.g. the Teiresias pattern algorithm). Attributes are assigned to the patterns based on the annotated SPAM email messages. The patterns with assigned attributes are used to analyze the query email message.

### FIELD OF THE INVENTION

The present invention relates to the automated analysis of electronic messages and, more particularly, to the automatic identification of unwelcome or unsolicited email messages, heretofore referred to as SPAM.

### BACKGROUND OF THE INVENTION

In recent years, electronic mail users around the world have been noticing that an ever increasing amount of unsolicited email reaches their mailboxes. The contents of such email ranges from get-rich-quickly schemes and low-priced printer cartridges, to stock tips, illegal substance offers, information on web sites with pornographic material, etc. Generally speaking, SPAM email can be divided into three main categories:
unsolicited, deceptive, fradulent or objectionable bulk email;
unsolicited, commercial bulk email (mortgage offers, on-line casinos, etc.); and,
unsolicited, non-commercial bulk email (e.g. joke of the day, political messages, etc.).

Recent estimates place the SPAM traffic to approximately 14 billion messages per day, or an average of approximately 25 messages per user per day! Despite the immensity of these numbers, it is only several tens of people that are responsible for the generation of these daily messages.

It is currently believed that only 1 in every 40,000 people who receive SPAM will actually launch a complain. An even smaller number, 1 in 200,000 people will actually respond to the SPAM. At an estimated $10 of gains per respondent, the daily SPAM traffic actually amounts to a $250M market annually. However, the cost that SPAM incurs in the form of lost productivity is estimated to be 100-fold, or $20B in 2003. And this cost is expected to rise to $200B by 2007 as a consequence of an anticipated increase in the number of SPAM messages.

Following the surge in the amount of circulating SPAM email, a number of methods have been proposed that can address the problem in a number of ways. The methods that are currently in use include blacklists, bulk email detection and filtering. Blacklist methods block all incoming email that is sent by known spammers. Bulk email detection methods rely on the detection of high-volume SMTP sessions and the blocking of the corresponding messages. Finally, filtering methods look at the content of the message under examination and try to determine whether it should be classified as SPAM or non-SPAM email.

Within the filtering category, one can further recognize three sub-categories: bayesian-based schemes, rule-based schemes and similarity-based schemes. Bayesian methods require a body of known SPAM and true email in order to train the underlying classifier. During the classification stage, these methods determine the degree of SPAM-iness of a message by combining the probabilities of the words in the message, and assuming that the words are independent. Bayesian methods are very good in identifying SPAM messages and generally exhibit low false-positive rates. On the other hand, rule-based methods apply heuristic tests on the headers or bodies of messages and can achieve good levels of SPAM recognition but they require that every rule be added explicitly in the collection which is in use. In the final subcategory of methods, we have the similarity-based methods which rely on the concept of ‘honeypots’ (i.e. fake email addresses that are published on-line) to generate a knowledge base of true SPAM. When presented with a message to examine, similarity-based methods compare it with those messages that exist in the honeypot-derived knowledge base to draw conclusions. The performance of these methods suffers when a newly-arrived SPAM message is a ‘pioneer’ of sorts, in that it does not have any counterpart among the messages in the knowledge base. The method we present below belongs in this last subcategory of filtering schemes.

### SUMMARY OF THE INVENTION

The present invention provides techniques for labeling a given email message as SPAM or non-SPAM email. The method comprises the following steps. Patterns associated with a knowledge base of SPAM messages are accessed, as by use of a pattern discovery algorithm, such as the Teiresias algorithm. One or more attributes may be assigned to these patterns. Subsequently, the patterns with their assigned attributes are used to analyze the email message under consideration.

The patterns with assigned attributes may be used to define an attribute vector, the attribute vector characterizing portions of a query email message email message of language characters. The patterns with assigned attributes may be stored in a database. As will be understood, the query email message under consideration may comprise letters or other characters from one or more languages of choice. The attribute vector may comprise a number of counters, wherein the number of counters is proportional to the number of letter in the email message. The assigned attributes may be used to contribute values to counters of the attribute vector that correspond to portions of the email message matched by the corresponding patterns. Further, a score may be determined for the patterns with assigned attributes used to define the attribute vector, wherein the score represents a degree of similarity between the email message being considered and whole or partial messages in the message database which gave rise to the patterns in the first place.

The present invention broadly provides a method for annotating a query email message, the method comprising the steps of:
accessing patterns associated with a database comprising annotated email messages;
assigning attributes to the patterns based on the annotated email messages; and
using the patterns with assigned attributes to analyze the query email message.

Preferably, the step of accessing patterns comprises using a pattern discovery algorithm, such as the Teiresias pattern algorithm.

According to a preferred embodiment, the steps of accessing patterns and assigning attributes are carried out independently of and prior to (i.e. “off line”) the step of using the patterns with assigned attributes to analyze the query email message.

Preferably, the novel method further comprises the step of selecting the accessed patterns that match the query email message.

Advantageously, the method further comprises the step of storing the patterns with assigned attributes in a database.

According to a preferred embodiment, the using step further comprises the step of defining an attribute vector from the patterns with assigned attributes, the attribute vector characterizing at least portions (or even the whole) of the query email message. Preferably, the attribute vector comprises a number of-counters. In a preferred embodiment, the query email message comprises characters of a human language and the number of counters is proportional to the number of such characters in the query email message.

In a preferred embodiment, the assigned attributes are used to contribute values to counters of the attribute vector corresponding to portions of the query email message matched by the patterns.

Preferably, one or more of said annotated email messages comprises an unwelcome email message (“SPAM”). Alternatively, one or more of said annotated email messages may comprise a welcome email message (“non-SPAM”). Patterns with assigned attributes of one or both of these SPAM and non-SPAM messages may be stored in a database that serves as a SPAM dictionary, which will be described hereinafter.

For example, the database may comprise (i) a first subdatabase comprising annotated unwelcome email messages (“SPAM”), and (ii) a second subdatabase comprising annotated welcome email messages (“non-SPAM”).

In a preferred embodiment, the method utilizes a plurality of attribute vectors. For example, each attribute vector of the plurality of attribute vectors may represent a different attribute. Further, the plurality of attribute vectors may be normalized and may preferably be ranked, only highly ranked attribute vectors being kept.

According to a preferred embodiment, the novel method further comprises the step of determining a score for the patterns with assigned attributes used to contribute to the attribute vector. This score preferably represents a degree of similarity between the query email message and at least one annotated email message of the database, where this one annotated email message may be an unwelcome (SPAM) message, or alternatively it may be a welcome (non-SPAM) message.

According to a preferred embodiment, in the step of determining a score for the patterns with assigned attributes used to contribute to the attribute vector, the database may comprise (i) a first subdatabase comprising annotated unwelcome email messages (“SPAM”), and (ii) a second subdatabase comprising annotated welcome email messages (“non-SPAM”), the aforesaid score representing a degree of similarity, between the query email message and at least one of said annotated unwelcome email messages (“SPAM”), and a degree of dissimilarity between the query email message and at least one of said annotated welcome email messages (“non-SPAM”).

According to a preferred embodiment, the inventive method further comprises the step of defining, for each of said assigned attributes, a value criterion based on the value of the counters of the attribute vector to determine whether the corresponding attribute is present in the query email message.

According to another embodiment, the method further comprises the step of defining a SPAM attribute criterion dependent on which of said assigned attributes are present in the query email message, to determine whether the query email message is a SPAM email message.

According to another embodiment, the method further comprises the step of defining a non-SPAM attribute criterion dependent on which of said assigned attributes are present in the query email message, to determine whether the query email message is a non-SPAM email message.

The invention also broadly provides an apparatus for annotating a query email message, the apparatus comprising:
a memory; and
at least one processor, coupled to the memory, operative to:
access patterns associated with a database comprising annotated email messages;
assign attributes to the patterns based on the annotated email messages; and
use the patterns with assigned attributes to analyze the query email message.

The at least one processor is preferably further operative to select the accessed patterns that match the query email message. In accordance with the using operation the at least one processor is further operative to define an attribute vector, as discussed hereinabove, from the patterns with assigned attributes, the attribute vector characterizing portions of the query email message. The annotated messages my be SPAM or non-SPAM, as discusssed earlier. Moreover, the database may comprise (i) a first subdatabase comprising annotated unwelcome email messages (“SPAM”), and (ii) a second subdatabase comprising annotated welcome email messages (“non-SPAM”). Moreover, the at least one processor is preferably further operative to determine a score for the patterns with assigned attributes used to contribute to the attribute vector. As discussed earlier, such a score preferably represents a degree of similarity between the query email message and the annotated email messages of the database which may take various SPAM and non-SPAM forms.

The invention further broadly provides an article of manufacture for annotating a query email message, comprising a machine readable medium containing one or more programs which when executed implement the steps of:
accessing patterns associated with a database comprising annotated email messages;
assigning attributes to the patterns based on the annotated email messages; and
using the patterns with assigned attributes to analyze the query email message.

According to a preferred embodiment the novel article implement a step of selecting the accessed patterns that match the query email message. Preferably, the article implements the further step of defining an attribute vector, as discussed hereinabove, from the patterns with assigned attributes, the attribute vector characterizing portions of the query email message. The annotated messages my be SPAM or non-SPAM, as discusssed earlier. Moreover, the database may comprise (i) a first subdatabase comprising annotated unwelcome email messages (“SPAM”), and (ii) a second subdatabase comprising annotated welcome email messages (“non-SPAM”). Moreover, the article preferable implements a step of determining a score for the patterns with assigned attributes used to contribute to the attribute vector. As discussed earlier, such a score preferably represents a degree of similarity between the query email message and the annotated email messages of the database which may take various SPAM and non-SPAM forms.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating an exemplary implementation for storing patterns with assigned attributes in a database, such as a SPAM dictionary, according to an embodiment of the present invention;

FIG. 2 is a schematic diagram illustrating an exemplary methodology for classifying a query sequence according to an embodiment of the present invention;

FIG. 3 is a flow chart illustrating an exemplary methodology for automatically labeling a query email message according to an embodiment of the present invention;

### DETAILED DESCRIPTION OF PREFERRED EMBODIMENTS

The present invention will be described below in the context of an illustrative labeling of an email message which for the most part contains letters from a natural human language possibly interspersed with HTML directives etc. However, it is to be understood that the present invention is not limited to such a particular representation of an email message. Rather, the invention is more generally applicable to any representation of an email message, as would be apparent to a person of ordinary skill in the art. Thus, the teachings of the present invention should not be construed as being limited to the analysis of email messages written in a given natural language, e.g. English, and possibly using punctuation or other distinguishable marks. As such, the teachings of the present invention are more generally applicable.

Automated elucidation of an email message's SPAM nature, as described herein, is beneficial as it minimizes the amount of manual labor that is associated with the cleanup of one's mailbox from SPAM messages. The automated elucidation process typically proceeds by accessing repositories of previously accumulated knowledge and using computation, i.e., in silico approaches, to replace generally tedious manual analysis. The automated identification of a SPAM email directly from the processing of the symbols contained in the message, in an automated or semi-automated manner, is an important goal as it will permit one to successfully intercept and delete SPAM messages before they reach their destination. The goal here is that a successful method will result in even fewer email users being reached by SPAM—the cost of sending SPAM will thus increase whereas the monetary profit of those whose business are advertised will decrease, hopefully to a point that the whole SPAM process will be financially unfavorable.

Numerous methods have been proposed for automatically determining whether a given email message is SPAM or not. These methods all essentially make use of the “guilty by association” approach. The “guilty by association” approach operates on the general principal that if a given segment of one email message has a particular property associated with it, then all email messages having that same segment (or some variation of it) also have that property. The “guilty by association” approach is equally applicable when the subject sequence is an email message. These methods can be divided into a number of well differentiated categories depending on the nature of the exploited information and the manner in which the information is used—see also above for an explanation.

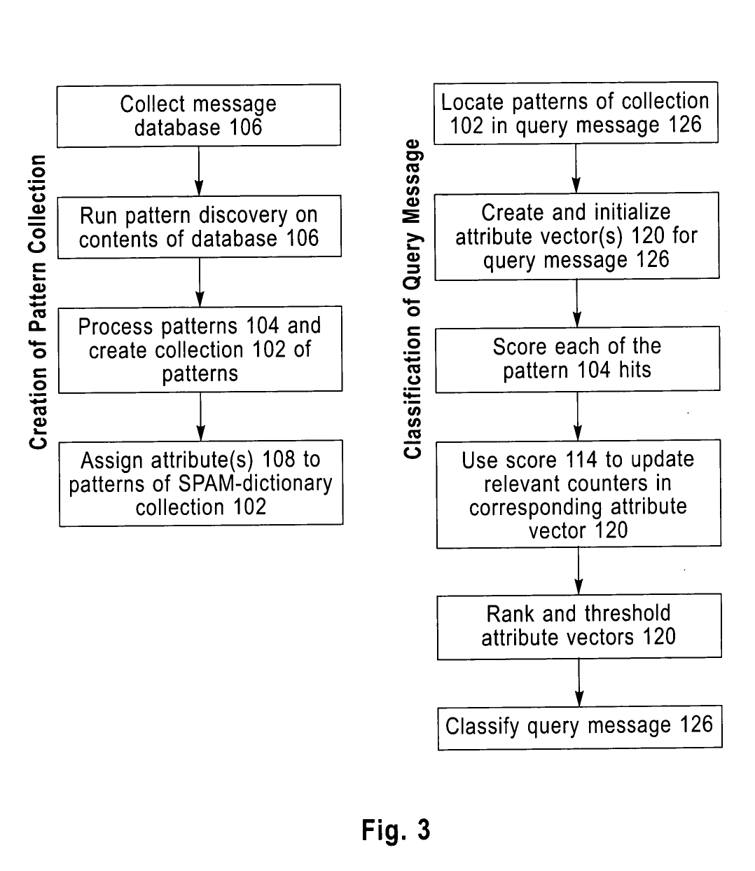

FIG. 3 shows a flow chart illustrating an exemplary methodology for automatically labeling an email message according to an embodiment of the present invention;
To form a database or collection or SPAM-dictionary 102, patterns 104 derived from and associated with a database 106 of known SPAM messages are accessed. Patterns 104 may be derived from annotated database 106. Each pattern of patterns 104, by virtue of the fact that it is a pattern, occurs two or more times in annotated database 106.

The patterns 104 may be assigned attributes based on the annotated messages of annotated database 106, from which patterns 104 are derived. Optionally, patterns 104 may additionally be assigned an estimate of the probability that the pattern occurs randomly. Patterns with assigned attributes constitute the SPAM-dictionary 102. The attributes represent identified features of the annotated database messages. Thus, an attribute may represent the following, non-exhaustive list of properties relating to messages, i.e., annotated database 106: whether it is a “spam” or “non-SPAM email” message, the source of the message being processed, routing information for the message being processed, whether the recipient's name appears in the “To:” or “Cc:” line of the message being processed, etc. A further detailed description of the formation of a SPAM-dictionary will be presented below.

Annotated database 106 may be any database, or combination of databases, comprising one or more annotated messages. Annotated database 106 may comprise annotated messages corresponding to SPAM—these would be messages collected through a honeypot or similar scheme. Annotated database 106 may also comprise annotated messages corresponding to “non-spam-email”—these messages could be collected through a number of methods.

To annotate a query message, patterns with assigned attribute 108 that match query message 126 are selected from SPAM-dictionary 102. While the present description involves the use of a set number of patterns with assigned attributes, i.e., three patterns with assigned attributes, namely, patterns with assigned attribute 108 the teachings of the present invention should not be limited to any particular number of patterns or attributes. For example, in accordance with the teachings of the present invention, the number of patterns with assigned attributes may be varied and arbitrary. Each of the patterns with attribute 108 may be scored. The score can be arbitrarily fixed, or can vary based on a number of predetermined criteria.

Thus, score 114 may be determined for patterns with assigned attribute 108. A further detailed description of how to determine a score will be presented below. Score 114 may then be used to determine an amount that patterns, with assigned attribute 108, contribute to attribute vector 120. Attribute vector 120 is a representation of the probability that one or more locations within the query message 126, that is being examined, contain one or more instances of the particular attributes associated with patterns with assigned attribute 108. A further detailed description of attribute vectors will be provided below.

An exemplary apparatus as a hardware implementation of the invention for annotating a query message in accordance with one embodiment of the present invention will be discussed briefly. The novel apparatus may comprise a computer system that includes a processor, a network interface, a memory, a media interface and an optional display. The network interface allows the computer system to connect to a network, while the media interface allows the computer system to interact with a media, such as a Digital Versatile Disk (DVD) or a hard drive.

As is known in the art, the methods and apparatus discussed herein may be distributed as an article of manufacture that itself comprises a machine readable medium containing one or more programs which when executed implement embodiments of the present invention. For instance, the machine readable medium may contain a program configured to access patterns associated with a database comprising annotated messages; select the accessed patterns that match the query sequence; assign attributes to the patterns based on the annotated messages; and use the patterns with assigned attributes to analyze the query message. The machine readable medium may be a recordable medium (e.g., floppy disks, hard drive, optical disks such as a DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

The processor of the novel apparatus can be configured to implement the methods, steps, and functions disclosed herein. The memory could be distributed or local and the processor could be distributed or singular. The memory could be implemented as an electrical, magnetic or optical memory, or any combination of these or other types of storage devices. Moreover, the term “memory” should be construed broadly enough to encompass any information able to be read from or written to an address in the addressable space accessed by the processor. With this definition, information on a network, accessible through the network interface, is still within the memory because the processor can retrieve the information from the network. It should be noted that each distributed processor that makes up processor generally contains its own addressable memory space. It should also be noted that some or all of the computer system can be incorporated into an application-specific or general-use integrated circuit.

An optional video display is any type of video display suitable for interacting with a human user of the novel apparatus. Generally, the video display is a computer monitor or other similar video display.

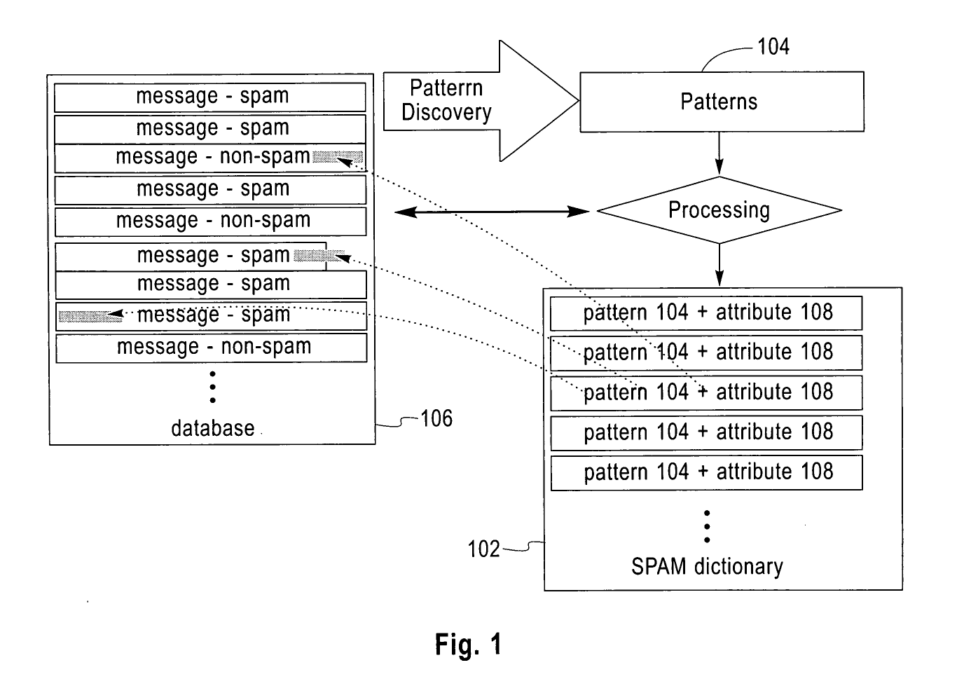

It is to be understood that the following description exemplifies the formation of a SPAM dictionary as referred to in conjunction with the formation of SPAM dictionary 102 of FIGS. 1 and 3. The formation of SPAM dictionary 102 involves using a pattern discovery algorithm, such as the Teiresias pattern algorithm, to process very large databases of annotated messages and fragments (e.g. annotated database 106) and to derive patterns 104 that appear within individual messages, as well as within different messages. Importantly, the patterns, such as patterns 104, may serve to completely describe the messages of the database at the individual character level. Examples of such patterns include but are not limited to: “+/MCP_TRAINI”, “+/MONTH_WITH”, “+/NE.+/MCP_T”, “+/R3??′K?A″”, “+/TIRAMINTIY”, “+/TPVEFBK28J”, “+/TRWJPEONM0”, “+/UY+VF_CFG”. “+/XZ/HSBK..U” and “+/YR</FONT><”.

In terms of the notation used, the symbol ‘.’ denotes a single position wild-card character that can represent any one character from the used symbol set.

The derived patterns, i.e., patterns 104, may be treated as a current vocabulary for the annotated messages to the extent that the database used is kept up to date. The association of patterns 104 with annotation information, which is contained in a typical entry of annotated database 106, comprises SPAM-dictionary 102. In general, the term “SPAM-dictionary” may be used to refer to any collection of patterns derived as above. In this particular embodiment, the term “SPAM dictionary” refers to patterns 104 that have been augmented so as to have attributes representing the annotations of annotated database 106 assigned to them.

Some of the key elements behind the idea of the SPAM-dictionary, and details for construction of a collection of patterns for the special case where the database comprises sequences of amino acids can be found in I. Rigoutsos et al. “Dictionary Building Via Unsupervised Hierarchical Motif Discovery In the Sequence Space of Natural Proteins,” Proteins: Struct. Funct. Genet. 37, 264-77, 1999, the disclosure of which is incorporated by reference herein. A discussion and description of potential uses for the dictionary described in this last publication appear in, I. Rigoutsos, “The Emergence of Pattern Discovery Techniques in Computational Biology,” Metabolic Engineering, 2, 159-77, 2000, the disclosure of which is incorporated by reference herein, and can be appropriately applied to SPAM by reference to the teachings of the present invention.

The following is an exemplary methodology for forming SPAM-dictionary 102. The SPAM-dictionary 102 should cover, as completely as possible, the sequences of annotated database 106. For the purposes of implementing an embodiment of the present methodology, we have used a collection of approximately 100,000 SPAM messages that have been collected using various methods from the email messages that are incoming to IBM's TJ Watson Research Center. This collection is approximately 600 million characters in size. The method can optionally generate patterns from only the “bodies” of the email messages in the database, or only the “headers” of the email messages in the database, or both. In what follows, we describe an embodiment that makes use of only the “bodies,” and the extension to the case where patterns are generated from the “headers” of the messages is an obvious, trivial extension.

The above database may be processed in two phases. In the first phase, a pattern discovery algorithm such as the Teiresias algorithm (using the parameters L equals 12, W equals 12 and K equals two) generates variable length patterns of characters containing no wild cards. The algorithm may optionally be permitted to enter its “convolution phase” or terminated at the end of its “scanning phase”. L and W represent integers defining the density of a pattern. K represents the minimum number of patterns within parameters L and W. A pattern has an <L, W> density if every substring of the pattern that starts and ends with a literal character and has a minimal length W and contains L or more characters. The use of the Teiresias algorithm to derive patterns is described in U.S. patent application Ser. No. 09/582,044, filed Jun. 21, 2000, entitled “Method and Apparatus for Performing Sequence Homology Detection,” the disclosure of which is incorporated by reference herein.

According to a second, optional phase, all instances of the patterns in the database may be located and masked, except possibly for the one pattern that appears in the longest database sequence. The Teiresias algorithm may then be rerun on the database sequences corresponding to the masked patterns, but this time using L equals 11 and W equals 11 and K equals 2. As before, the algorithm may optionally be permitted to enter its “convolution phase” or terminated at the end of its “scanning phase”. The second phase may be optionally repeated again by rerunning the Teiresias algorithm on the masked database as long as patterns are being generated.

The exemplary processing described herein requires approximately 1 (one) CPU hour worth of computation on an Intel Pentium processor with a clock speed of 2.4 GHz. The above phases generate a SPAM-dictionary suitable for use in the present invention. The exemplary SPAM-dictionary, as described herein, contains a combined total of approximately 7.0 million patterns accounting for more than 95 percent of the substrings of characters, or “bodies”, in the database messages at the character level. According to the methods highlighted above, the exemplary SPAM-dictionary will likely contain redundant patterns, i.e., a given position in a message of the processed database would participate in, and be covered by, multiple patterns contained in the SPAM-dictionary. The redundancy of representation is a desired property to be exploited during the classification of query messages. The methodology for creating a dictionary for the special case of biological sequences is described in U.S. patent application Ser. No. 09/582,045, filed Jun. 21, 2000, entitled “Method and Apparatus for Performing Pattern Dictionary Formation For Use in Sequence Homology Detection,” the disclosure of which is incorporated by reference herein.

As described above, the annotations of annotated database 106 are used to assign attributes to patterns 104. Any information, or category of information, of any database would be suitable for assigning attributes to the patterns in accordance with the teachings of the present invention.

The annotation information contained in annotated database 106 may be derived from preprocessing of the database messages through other means. In its simplest implementation, this invention assigns to each database message an “identity” attribute that can take values “spam” or “other”.

An optional additional phase makes use of the subset of database 106 that comprises “non-SPAM email” messages. One or more patterns 104 from the SPAM-dictionary collection 102 are sought in the non-SPAM messages of database 106. Each pattern 104 that is located in one or more non-SPAM messages of database 106 is optionally removed from the SPAM-dictionary 102 and the SPAM-dictionary is updated. Alternatively, each pattern 104 that is also present in one or more non-SPAM messages of database 106 is tagged as such.

An optional additional phase attaches to each pattern 104 an estimate of the probability that it occurs by chance.

It should be stressed at this point that several obvious variations exist that permit one to generate a collection of patterns 102. For example collection 102 could be created as the union of patterns 104 generated from processing only the SPAM-messages of database 106 and of patterns 104 generated from processing only the NON-SPAM-messages of database 106. Another way of creating the collection of patterns 102 is carry out pattern discovery on the SPAM-messages and NON-SPAM-messages simultaneously. Additional obvious variations are possible.

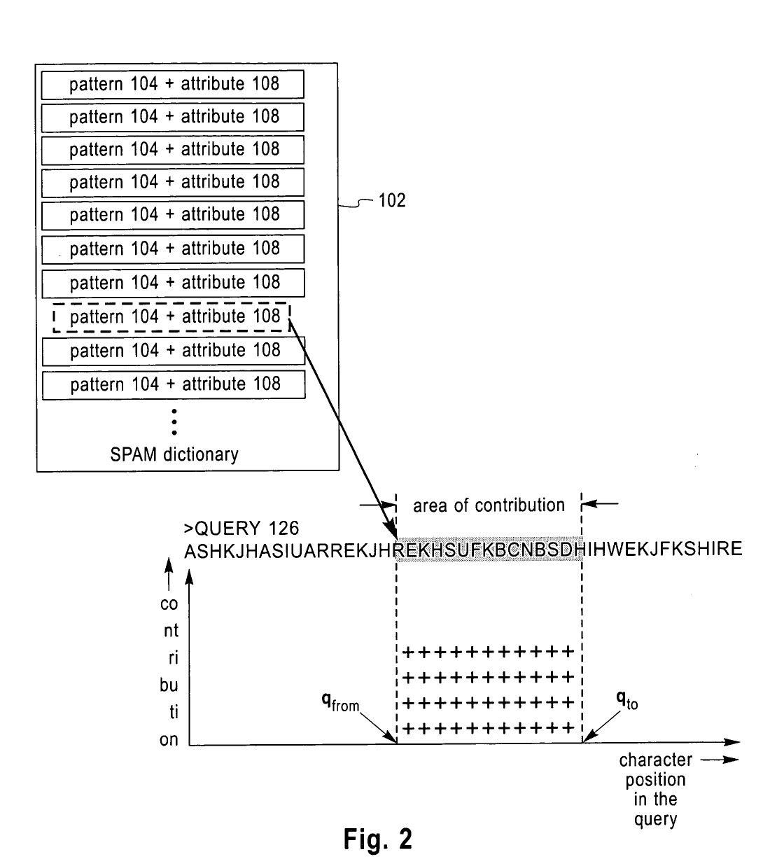

It is to be understood that the following description exemplifies the classification of a message as referred to in conjunction with the annotation of query message 126 of FIG. 2. When presented with a query message to classify, the following illustrative operations may be performed:

1) determine the subset S of patterns in the SPAM-dictionary that
match regions in the query Q with length |Q| ;
1b) optionally remove from the set S those patterns that are also
present in the NON-SPAM messages of database 106 (if known) or
that have high probability of occurring by chance.
2) for each pattern s in S do {

| | |
|---|---|
| 2a) | let q_{from} and qₜₒ denote the region in the query matched by s ; |
| 2b) | use the SPAM-dictionary information to access all instances |

of pattern s in the database of messages and let P denote the
set of corresponding messages;

| | |
|---|---|
| 2c) | for each message p in P { |
| | - let {p_{from},pₜₒ} denote the instance of pattern s in the |

database entry p under consideration ;
b

- optionally retrieve full record R for the respective

entry p ;

```
  - retrieve the 1st attribute ATT1 from the record R for p ;
  - if (ATT1 has not been encountered before) {
- create a one-dimensional score array with length |Q| ;
    - initialize the array to all 0's and set ATT1 as its
```

attribute ;

- assign CONTRIB({p_{from},pₜₒ},s) to the interval {q_{from},qₜₒ}

of this new array ;

```
        }
  else {
      - add CONTRIB({p_{from},pₜₒ},s) to interval {q_{from},qₜₒ} of
```

the already existing array with attribute ATT1 ;

| | } |
|---|---|
| 2d) | OPTIONAL STEP - repeat this process for other attributes of |

interes that are in record R ;

}

Patterns 104 with assigned attribute 108 are then optionally compared to query sequence 126. Any one of patterns with assigned attribute 108 may have more than one attribute assigned to it. If the pattern 104 under consideration has an attribute 108 attached to it that has not yet been encountered in relation to the particular query email message 126, then an attribute vector for that new particular attribute 108, is created. It is to be understood that the present description exemplifies the defining of an attribute vector as referred to in conjunction with the defining of attribute vector 120 of FIG. 3. Additionally, for ease of reference, the defining of an attribute vector will be described before the determining of a score for the patterns is described. An attribute vector is a convenient representation of information about the presence of a particular attribute 108 in the query email message sequence of language characters. The attribute vector described herein may contain a number of place holders equal to the length of the query sequence. However, while the present description involves use of an attribute vector 120 with place holders, any vector structure would be suitable in accordance with the teachings of the present invention. Further, any other data structure that permits the storage and access of information relating to annotation information may be used in the present invention.

Each of the place holders in the attribute vector 120 is associated with an accumulator, i.e., a counter. The counter initially has a value of zero. The pattern contributes to a region {q_{from}, qₜₒ} of the attribute vector 120 by contributing a value to the counters that correspond to the region, or regions, {q_{from}, qₜₒ} of the query sequence that are matched by the pattern. The counter, or counters, that have a value contributed to them are denoted by indicating the beginning and ending units, i.e., {q_{from}, qₜₒ} of the region. Thus, the first unit to the fifth unit would be presented as {1, 5}. The pattern may contribute values to the attribute vector in the form:
CONTRIB({p_{from}, pₜₒ}, s)
wherein the above expression indicates the amount of contribution a particular pattern, in this case pattern s, has contributed to the attribute vector in the region {p_{from}, pₜₒ}. The query sequence is thus annotated incrementally, one pattern at a time, by reference to the attributes of the matching pattern, or patterns, the patterns in turn being derived from the annotated database sequences.

If, on the other hand, a pattern has an assigned attribute that has already been encountered, the pattern merely adds the corresponding contribution value to the already existing value, or values of the corresponding counter, or counters. In the situation wherein the attribute has already been encountered and an attribute vector for that attribute already exists, additional patterns may contribute to the same counter, or counters, {q_{from}, qₜₒ} as previous patterns, or to different counters {q′_{from}, q′ₜₒ}, depending on which counter each pattern matches. Thus, the units {q_{from}, qₜₒ} to which the patterns contribute may or may not be overlapping.

After all patterns in the SPAM-dictionary have been exhausted, the attribute vectors may be sorted and ranked based on the total amount of accumulated contributions each attribute vector receives from the patterns. Any other suitable ranking or sorting methodologies may be used in accordance with the teachings of the present invention. The attribute vectors may be grouped into categories, i.e., by attribute, and ranked separately within each category. The top ranking vectors, T, of each category may be identified, to be presented to a user of the methodology in a coherent order. Each of these attribute vectors will contain non-zero values at precisely those counters {q_{from}, qₜₒ} that were matched by patterns carrying the same attribute. Clearly, of particular interest is the category corresponding to the identity-attribute of a message in the processed database and which at the very minimum assumes the values “spam” and “other”.

The annotation of the query sequence and the association of patterns with the corresponding information from the annotated sequences of the annotated database 106 may be performed in any order. For example, as is shown in FIG. 1, attributes are first assigned to patterns 104 to form the patterns with assigned attributes comprising SPAM-dictionary 102, and then patterns with assigned attribute 108 is used to annotate query sequence 126.

Generally, the SPAM-dictionary formed should not be seen as a collection of patterns each of which necessarily captures a single, unique attribute of the database message. While patterns assigned a specific, single attribute may be used in accordance with the teachings of the present invention, by design many of the patterns may also carry multiple attributes. Similarly, the SPAM-dictionary may also contain multiple patterns all of which are assigned the same attribute, or attributes. Further, there may be patterns that overlap with one another. Thus, a given region of a query sequence may also be covered by multiple patterns. Each of the patterns covering a region of the query sequence will in general be assigned one or more attributes that are used to analyze the query sequence by coloring the corresponding region, or regions, of the query sequence. When multiple patterns match a particular region of the query sequence, the patterns and the respective assigned attributes, may be ranked. For example, let a given region of the query sequence match a number of distinct patterns, M. In order for an attribute, e.g., “spam”, to gain a high ranking in the reported results, a large portion of M patterns must be assigned this attribute.

By definition, each of the patterns of the SPAM-dictionary must represent at least two regions in the database 106. Thus, if M patterns cover a given region in the query sequence, then the following two properties will simultaneously hold:
there exists a subset of database sequences, F, corresponding to all of the instances of the patterns, M, in the database, the database sequences, F, being similar with the character neighborhood surrounding this query position; and
the database sequences, F, will concur on the identity of each character contained in each of the patterns, M.

The database sequences, F, however, may or may not concur on the attribute to annotate the particular region of the query sequence. If N number of the F database sequences have a particular attribute, i.e., “SPAM”, at a particular region, then by the “guilty by association” approach, the chance that the same region of the query sequence also has that attribute, i.e., is also part of a database message, will be proportional to N/F. This concept may be applied to every attribute that is attached to a pattern.

A pattern does not have to match a database message in its entirety in order to be useful in analyzing a query message. Further, a pattern also does not have to have an attribute explicitly linked with it to be useful in analyzing the query sequence. In FIGS. 1 and 2 it is shown that a query email message email message 126 of characters is annotated using a SPAM-dictionary, and that pattern_{K} matches the region {q_{from}, qₜₒ} in the query message sequence. During the formation of the SPAM-dictionary 102 it was determined that pattern_{K} matches three regions in the message database. Following these three regions back to the database entries, it can be determined that in one of the database sequences, pattern_{K} spans an interval, {p_{from}, pₜₒ}, of a region of the database sequence, {feat_{from}, featₜₒ}, that is annotated as “feature-1”. The interval {i_{from}, iₜₒ} denotes the intersection of the intervals {p_{from}, pₜₒ} and {feat_{from},featₜₒ}. In this particular example, pattern_{K} contributes to the hypothesis of the presence of a partial “feature-1” in the query sequence by incrementing the support at the locations {q_{from}+(i_{from}−p_{from}), q_{from}+(iₜₒ−p_{from})} of the “feature-1” attribute vector, shown as the area of contribution.

If the query message contains a given attribute, then each one of the potentially numerous patterns that match the region of the query message corresponding to the attribute will cumulatively, as well as independently, provide support for the attribute at the respective region. Conversely, the number of patterns matching the query message may be used to determine whether the query message actually contains a given attribute. Namely, as the accumulated support for the attribute increases, i.e., as the number of patterns with the assigned attribute that match the region increases, so does the likelihood of the presence of the attribute in the query message.

An attribute vector may be defined from the patterns with assigned attributes, the attribute vector representing the query message, as described in conjunction with the defining of attribute vector 120 of FIG. 1. Following from the description of query message annotation above, if the query message is a true member of a family with “feature-1” then it is expected that the attribute vector “feature-1” that corresponds to this family will obtain support along its length from each pattern that matches the query message. Clearly, if the query message shares only a local region with a message in the database 106, then the corresponding attribute vector will have non-zero values corresponding only to the query sequence region in question.

It is to be understood that the following description exemplifies the determining of a score for the patterns with assigned attributes, as referred to in conjunction with the determining of score 114 for patterns with assigned attributes 108 of FIG. 1. In accordance with the teachings of the present invention, a weighted, position-specific scoring scheme may be used.

Above, it was described how the patterns with assigned attributes are used to contribute values to counters of the attribute vector corresponding to portions of the query message matched by the patterns. The amount each pattern will contribute to counters of the attribute vector corresponding to portions of the query message matched by the patterns will now be described.

For example, if pattern_{K} is one of the patterns matching a region of the query message, then 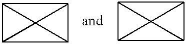
may be used to denote the characters representing instances of pattern_{K} in the query message and in the database message, d, respectively. Further, {i₁, . . . iₗ} and {j₁, . . . jₗ} may be used to denote the endpoints of the regions spanned by the pattern in the query message and the database message, d, respectively. Further, any pattern, i.e., pattern_{K}, that matches an entire region of database message, d, annotated with attribute A, is also annotated with attribute A.

Exemplary pattern_{K} may also bring together two sequence fragments each with lengths, i.e., measured as the number of characters in the message, equal to the span of the pattern_{K}, one fragment coming from the query message and the other coming from the database message d. The more similar these two fragments are to each other, the more likely it is that upon completion of the annotation of the query message, the attribute A that is associated with the region of database message, d, 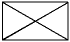
will be carried over to the region of the query message 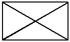
through the “guilty by association” approach. There is a rather straightforward manner in which pattern_{K} can contribute to the attribute vector for attribute A. A scoring matrix is used to generate contributions in a position- and content-dependent manner as follows: 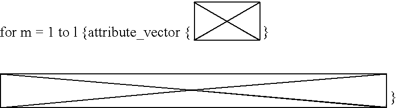
wherein m is a variable equivalent to the endpoints i of the region spanned by the pattern in the query message and j of the region spanned pattern in the database. In other words, the pattern will contribute to the (i₁+m−1)-th unit of the attribute vector an amount that relates to the degree of similarity between the characters occupying the positions 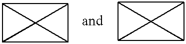
respectively.

A given pattern with assigned attributes will contribute to each of the attribute vectors that correspond to those attributes. The amount of these contributions will depend on how well an annotated database message with an instance of the attribute matches the instance in the query message. Thus, different attribute vectors will in general accumulate different amounts of contribution from the different patterns. Further, the amounts of these contributions will also depend on the position within the attribute vector.

During the annotation of the query message, a bookkeeping array, total, is maintained representing a message of a length equal to that of the query message. For every pattern with characters representing an instance 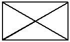
in the query sequence, total is updated as follows:

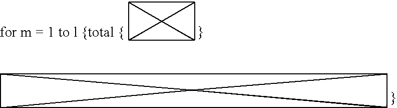

Thus, the i-th position of total is a number representing the number of patterns that have contributed to it. Each contribution is weighted by the degree of similarity between the character in the query message and the corresponding database message, as is done in defining the attribute vector. Note that at all times during processing, the value of total {i} is greater than or equal to the maximum value encountered in the i-th position of any of the attribute vectors for this query message.

Once all of the patterns matching the query message have been examined, the contents of the i-th position of each attribute vector can optionally be normalized by dividing by the value of total {i}. Multiplying the normalized value by 100 gives, for each attribute vector, a measure of the fraction of the total contribution that this attribute vector has received, as a function of position within the query message. Well conserved attributes are matched by a greater number of patterns, and thus will receive values close to 100 percent. Less well conserved attributes will be matched by fewer patterns and thus will receive lesser values. This particular way of normalizing additionally prevents the situation wherein regions of the query sequence having equal lengths receive disproportionately different contributions due to differences in the number of contributing patterns, i.e., as a result of overrepresentation in the database.

Once the units of the attribute vectors have been normalized, the units are sorted based on the total amount of contributions received. The top, T, ranking vectors are noted. Finally, an additional requirement may be imposed that any reported attributes be supported by non-zero values over a minimum number X of counters, the value of X being user-defined.

We have built a prototype implementation of this invention that used a database 106 containing 21,355 messages with an identity attribute “non-SPAM email” and 65,175 messages with identity attribute “spam” to generate the SPAM-dictionary. The system was tested on 86,481 messages of which 21,248 were known to be non-SPAM email and 65,233 were known to be true SPAM. The system was able to correctly classify 95.0% of the SPAM messages as “spam” without misclassifying any of the non-SPAM email messages, i.e. the false positive ratio observed during this experiment was 0.000%. The current throughput of the system on a Intel Pentium processor running at 2.5 GHz is approximately 30 messages per second; we anticipate that as our prototype matures the achieved throughput will improve.

Although illustrative embodiments of the present invention have been described herein, it is to be understood that the invention is not limited to those precise embodiments, and that vbarious other changes and modifications may be effected therein by one skilled in the art without departing from the scope or spirit of the invention.

1. A method for annotating a query email message, the method comprising the steps of:
accessing patterns associated with a database comprising annotated email messages;
assigning attributes to the patterns based on the annotated email messages; and
using the patterns with assigned attributes to analyze the query email message.

2. The method of claim 1, wherein the step of accessing patterns comprises using a pattern discovery algorithm.

3. The method of claim 1, wherein the pattern discovery algorithm is the Teiresias pattern algorithm.

4. The method of claim 1, wherein the steps of accessing patterns and assigning attributes are carried out independently of and prior to the step of using the patterns with assigned attributes to analyze the query email message.

5. The method of claim 1, further comprising the step of selecting the accessed patterns that match the query email message.

6. The method of claim 1, further comprising the step of storing the patterns with with assigned attributes in a database.

7. The method of claim 1, wherein the using step further comprises the step of defining an attribute vector from the patterns with assigned attributes, the attribute vector characterizing portions of the query email message.

8. The method of claim 1, wherein the using step further comprises the step of defining an attribute vector from the patterns with assigned attributes, the attribute vector characterizing the whole of the query email message.

9. The method of claim 1, wherein one or more of said annotated email messages comprises an unwelcome email message (“SPAM”).

10. The method of claim 9, further comprising the step of storing the patterns with assigned attributes in a database serving as a “SPAM-dictionary”.

11. The method of claim 1, wherein one or more of said annotated email messages comprises a welcome email message (“non-SPAM”).

12. The method of claim 11, further comprising the step of storing the patterns with assigned attributes in a database serving as a “SPAM-dictionary”.

13. The method of claim 1, wherein said database comprises (i) a first subdatabase comprising annotated unwelcome email messages (“SPAM”), and (ii) a second subdatabase comprising annotated welcome email messages (“non-SPAM”).

14. The method of claim 7, wherein the attribute vector comprises a number of counters.

15. The method of claim 14, wherein the query email message comprises characters of a human language and the number of counters is proportional to the number of said characters in the query email message.

16. The method of claim 14, wherein the assigned attributes are used to contribute values to counters of the attribute vector corresponding to portions of the query email message matched by the patterns.

17. The method of claim 7, comprising a plurality of attribute vectors.

18. The method of claim 17, wherein the values contributed to the counters of each of the attribute vectors of the plurality of attribute vectors are normalized.

19. The method of claim 17, wherein each attribute vector of the plurality of attribute vectors represents a different attribute.

20. The method of claim 17, wherein the plurality of attribute vectors are ranked.

21. The method of claim 20, wherein only highly ranking attribute vectors are kept.

22. The method of claim 1, further comprising the step of determining a score for the patterns with assigned attributes used to contribute to the attribute vector.

23. The method of claim 22, wherein the score represents a degree of similarity between the query email message and at least one annotated email message of the database.

24. The method of claim 23, wherein the score is normalized.

25. The method of claim 22, wherein the score represents a degree of similarity between the query email message and at least one annotated email message of the database, and wherein said at least one of said annotated email messages comprises an unwelcome email message (“SPAM”).

26. The method of claim 22, wherein the score represents a degree of similarity between the query email message and at least one annotated email message of the database, and wherein said at least one of said annotated email messages comprises a welcome email message (“non-SPAM”).

27. The method of claim 1, further comprising the step of determining a score for the patterns with assigned attributes used to contribute to the attribute vector, said database comprising (i) a first subdatabase comprising annotated unwelcome email messages (“SPAM”), and (ii) a second subdatabase comprising annotated welcome email messages (“non-SPAM”), said score representing a degree of similarity, between the query email message and at least one of said annotated unwelcome email messages (“SPAM”), and a degree of dissimilarity between the query email message and at least one of said annotated welcome email messages (“non-SPAM”).

28. The method of claim 27, further comprising the step of defining, for each of said assigned attributes, a value criterion based on the value of the counters of the attribute vector to determine whether the corresponding attribute is present in the query email message.

29. The method of claim 27, further including the step of defining a SPAM attribute criterion dependent on which of said assigned attributes are present in the query email message, to determine whether the query email message is a SPAM email message.

30. The method of claim 27, further including the step of defining a non-SPAM attribute criterion dependent on which of said assigned attributes are present in the query email message, to determine whether the query email message is a non-SPAM email message

31. An apparatus for annotating a query email message, the apparatus comprising:
a memory; and
at least one processor, coupled to the memory, operative to:
access patterns associated with a database comprising annotated email messages;
assign attributes to the patterns based on the annotated email messages; and
use the patterns with assigned attributes to analyze the query email message.

32. The apparatus of claim 31, wherein the at least one processor is further operative to select the accessed patterns that match the query email message.

33. The apparatus of claim 31, wherein in accordance with the using operation the at least one processor is further operative to define an attribute vector from the patterns with assigned attributes, the attribute vector characterizing portions of the query email message.

34. The apparatus of claim 31, wherein at least one of said annotated email messages comprises an unwelcome email message (“SPAM”).

35. The apparatus of claim 31, wherein at least one of said annotated email messages comprises a welcome email message (“non-SPAM”).

36. The apparatus of claim 31, wherein said database comprises (i) a first subdatabase comprising annotated unwelcome email messages (“SPAM”), and (ii) a second subdatabase comprising annotated welcome email messages (“non-SPAM”).

37. The apparatus of claim 33, wherein the attribute vector comprises a number of-counters.

38. The apparatus of claim 37, wherein the query email message comprises characters of a human language and the number of counters is proportional to the number of said characters in the query email message.

39. The apparatus of claim 37, wherein the assigned attributes are used to contribute values to counters of the attribute vector corresponding to portions of the query email message matched by the patterns.

40 The apparatus of claim 33, comprising a plurality of attribute vectors.

41. The apparatus of claim 39, wherein each attribute vector of the plurality of attribute vectors represents a different attribute.

42. The apparatus of claim 39, wherein the plurality of attribute vectors are ranked.

43. The apparatus of claim 31, wherein the at least one processor is further operative to determine a score for the patterns with assigned attributes used to contribute to the attribute vector.

44. The apparatus of claim 43, wherein the score represents a degree of similarity between the query email message and the annotated email messages of the database.

45. The apparatus of claim 43, wherein the score represents a degree of similarity between the query email message and at least one of the annotated email messages of the database, and wherein said at least one of said annotated email messages comprises an unwelcome email message (“SPAM”).

46. The apparatus of claim 43, wherein the score represents a degree of similarity between the query email message and at least one of the annotated email messages of the database, and wherein said at least one of said annotated email messages comprises a welcome email message (“non-SPAM”).

47. The apparatus of claim 31, wherein the at least one processor is further operative to determine a score for the patterns with assigned attributes used to contribute to the attribute vector, said database comprising (i) a first subdatabase comprising annotated unwelcome email messages (“SPAM”), and (ii) a second subdatabase comprising annotated welcome email messages (“non-SPAM”), said score representing a degree of similarity, between the query email message and said annotated unwelcome email messages (“SPAM”), and a degree of dissimilarity between the query email message and said annotated welcome email messages (“non-SPAM”).

48. An article of manufacture for annotating a query email message, comprising a machine readable medium containing one or more programs which when executed implement the steps of:
accessing patterns associated with a database comprising annotated email messages;
assigning attributes to the patterns based on the annotated email messages; and
using the patterns with assigned attributes to analyze the query email message.

49. The article of manufacture of claim 48, further comprising the step of selecting the accessed patterns that match the query email message.

50. The article of manufacture of claim 48, wherein the using step further comprises defining an attribute vector from the patterns with assigned attributes, the attribute vector characterizing portions of the query email message.

51. The article of manufacture of claim 48, wherein at least one of said annotated email messages comprises an unwelcome email message (“SPAM”).

52. The article of manufacture of claim 48, wherein at least one of said annotated email messages comprises a welcome email message (“non-SPAM”).

53. The article of manufacture of claim 48, wherein said database comprises (i) a first subdatabase comprising annotated unwelcome email messages (“SPAM”), and (ii) a second subdatabase comprising annotated welcome email messages (“non-SPAM”).

54. The article of manufacture of claim 50, wherein the attribute vector comprises a number of-counters.

55. The article of manufacture of claim 54, wherein the query email message comprises characters in a human language and the number of counters is proportional to the number of said characters in the query email message.

56. The article of manufacture of claim 54, wherein the assigned attributes are used to contribute values to counters of the attribute vector corresponding to portions of the query email message matched by the patterns.

57. The article of manufacture of claim 50, comprising a plurality of attribute vectors.

58. The article of manufacture of claim 57, wherein each attribute vector of the plurality of attribute vectors represents a different attribute.

59. The article of manufacture of claim 57, wherein the plurality of attribute vectors are ranked.

60. The method of claim 48, further comprising the step of determining a score for the patterns with assigned attributes used to contribute to the attribute vector.

61. The article of manufacture of claim 60, wherein the score represents a degree of similarity between the query email message and the annotated email messages of the database.

62. The article of manufacture of claim 60, wherein the score represents a degree of similarity between the query email message and at least one of the annotated email messages of the database, and wherein said at least one of said annotated email messages comprises an unwelcome email message (“SPAM”).

63. The method of claim 60, wherein the score represents a degree of similarity between the query email message and at least one of the annotated email messages of the database, and wherein said at least one of said annotated email messages comprises a welcome email message (“non-SPAM”).

64. The article of manufacture of claim 50, further comprising the step of determining a score for the patterns with assigned attributes used to contribute to the attribute vector, said database comprising (i) a first subdatabase comprising annotated unwelcome email messages (“SPAM”), and (ii) a second subdatabase comprising annotated welcome email messages (“non-SPAM”), said score representing a degree of similarity, between the query email message and at least one of said annotated unwelcome email messages (“SPAM”), and a degree of dissimilarity between the query email message and at least one of said annotated welcome email messages (“non-SPAM”).
